(19) United States
(12) Patent Application Publication
(10) Pub. No.: US 2010/0113298 A1
(43) Pub. Date: May 6, 2010

(54) DETECTION OF RNA WITH MICRO-ARRAYS

(75) Inventors: SIMON MAUCH, BONN (DE); ALEXANDRA HEIM, ERLANGEN (DE)

Correspondence Address: KNOBBE MARTENS OLSON & BEAR LLP, 2040 MAIN STREET, FOURTEENTH FLOOR, IRVINE, CA, 92614, US

(73) Assignee: EPPENDORF AG, HAMBURG (DE)

(21) Appl. No.: 12/546,555

(22) Filed: Aug. 24, 2009

Related U.S. Application Data
(63) Continuation of application No. 12/272,524, filed on Nov. 17, 2008, now abandoned.
Application No. 12/272,524 is a continuation of application No. 11/596,120, now abandoned.

(30) Foreign Application Priority Data
May 12, 2004 (DE) 10 2004 023 439.6

(51) Int. Cl. C40B 30/04

(52) U.S. Cl. 506/9

(57) ABSTRACT

A method for the detection and quantification of RNA via micro-arrays, wherein a first DNA molecule is added to a RNA-pool to be tested, which first DNA molecule is complementary to at least a first segment of a RNA of interest, as well as a second DNA molecule complementary to a second segment of the RNA of interest, which second segment is different from said first segment and further has at the 3′ and 5′ ends specific nucleotide sequences, which are not complementary to the RNA of interest. The DNA molecules are contacted with the RNA-pool under conditions allowing hybridization of complementary strands. Afterwards all RNA molecules are removed to which said first DNA molecule has not hybridized. After releasing of the second DNA molecules, they are contacted with an array having at specific locations thereof probes specific for particular nucleotide sequences.

### RELATED APPLICATIONS

This application is a Continuation of U.S. application Ser. No. 12/272,524, filed Nov. 17, 2008, which is a Continuation of U.S. application Ser. No. 11/596,120, filed Nov. 9, 2006, which is a U.S. National Phase of International Application No. PCT/EP2005/004425, filed Apr. 25, 2005, designating the U.S., which claims the benefit of German Application No. DE 10 2004 023 439.6, filed May 12, 2004.

### FIELD OF THE INVENTION

The present invention relates to a method for detecting and quantifying RNA with micro-arrays. In particular, the present invention relates to a method, wherein to a RNA-pool to be tested a first DNA-molecule is added, which first DNA-molecule is complementary to at least a first segment of a RNA of interest, and wherein also a second DNA-molecule is added, which is complementary to a second segment of the RNA of interest, which second segment is different from said first segment. The DNA-molecules are contacted with said RNA-pool under conditions, which allow hybridization of complementary strands. After isolation of the RNA and formed heteroduplexes, the second DNA-molecule is released, and the presence thereof is determined on micro-arrays.

### DESCRIPTION OF THE RELATED ART

Differential transcription of genes as well as the accompanying altered production of proteins are utilized in biological systems to adapt to changed external influences or to effect a differentiation of the cell to an different phenotype. In cells also changes in the genome caused by external influences may occur, which result in a change of the nucleotide sequence in the genomic DNA and as a result thereof in the transcription of modified proteins or to an adjusted, e.g., increased, transcription of the genes themselves. Such changes may have a profound effect on biological processes, such as e.g., the generation of tumor cells, etc.

According to conventional molecular biological methods, the investigation of such processes/changes normally consisted in a “1-Gen-1-Experiment” assay, which, however, allowed the determination a limited number of biological processes only.

In the recent past, so-called micro-arrays have been developed, which allow the detection of a wide variety of different biological entities at the same time. A micro-array normally consists of a support made of materials such as e.g., glass, silicon or nylon, onto which on known locations an array of molecules is applied. Since the segment covered by said locations on the support ranges of from about 20-200 μm, or even less, the biological molecules may be arranged on the support in a high density.

These kind of micro-arrays allow a fast and cost effective assessment of e.g., the gene expression and/or genetic changes in a biological entity. A normal assay utilizing micro arrays and nucleotides as the probe and target molecules may be described as follows: probe-nucleotides with a size of about 500 to 2000 bases are immobilized in a known arrangement on a suitable carrier, e.g., a glass disc. Subsequently, the sample to be tested is contacted with the support under conditions, which allow a hybridization of complementary strands. Not-complementary strands, which do not hybridize to the probes on the support, are removed. The locations on the micro-array containing nucleotide double strands are detected and allow a conclusion with respect to the sequence and amount of nucleic acid within the sample tested.

In the art micro-arrays have been used for a variety of different purposes. For example, micro-arrays are utilized in a respective procedure for the analyses of transcription/expression profiles of cells, thus, for the detection and characterization of the entirety of mRNA-sequences, which are expressed by specific cells (c.f. Lockhart et al., Nat. Biotechnol. 14 (1996), 1675-1680).

A shortcoming of such examinations resides at least in part in the purity of the sample to be tested, wherein in some cases the samples be tested are contaminated, which in effect may impede a specific hybridization, required for allowing a reliable conclusion. In particular, chemicals like phenol, which are used for the purification of the mRNA, or also the subsequent marking efficiency of the biological molecule may tamper the results. Another problem resides in that specific nucleotides within the samples to be tested are present in very low amounts only, so that these molecules resist in most cases a detection via conventional micro-array assays.

In these cases, so as to obtain in such cases an improved signal strength, it has been proposed to amplify the starting material. One approach in this regard comprised the preparation of cDNA from a RNA-pool, with the poly-dT primer used for this purpose containing at the 5′-end the nucleotide sequence of the T7-promoter. After formation of the heteroduplex and alkaline denaturation, the second DNA-strand is synthesized making use of the hairpin-structure at the 3′-end of the cDNA as a primer and is opened by means of nuclease Si to the linear double strand. The DNA double strand afterwards serves as a matrix for the T7-RNA-polymerase. The RNA obtained thereby serves in turn as primer for cDNA synthesis.

This approach brings along the disadvantage, that the entire RNA-pool is amplified, whereas populations of ribonucleotides and cDNA-molecules, respectively, are generated, which do not correspond in amount produced to their procentual presence in the original population. In addition, artifacts are generated, which disturb the subsequent analysis.

A method for the detection of viral contaminations in water samples is disclosed by Regan, P. M. and Margolin, A. B. (Journal of Virological Methods 64 (1997), 65-72). Poliovirus RNA has been isolated by means of magnetic beads and hybridized to biotinylated oligonucleotide probes. Hybridized probes are subsequently amplified and detected.

In Armour, A. L. et al. (Nucleic Acids Research Vol. 28, No. 2 (2000), 605-9), the detection of the copy number at distinct genetic loci is disclosed. Test-DNA is denatured, immobilized on a filter and hybridized with an excess of probe. After a washing step, attached probes are amplified and quantified.

A method for the detection of particular organisms in a sample is disclosed in WO 00/77260. Characteristic segments of genomic DNA of the organisms to be detected are hybridized to specific probes, selectively amplified and detected.

Methods for the detection of deletions in a target-DNA, particularly of deletions comprising some kilobases in length, are disclosed by Sellner, L. N. and Taylor, G. R. (human mutation 23 (2004), 413-9). The methods comprise the multiplex amplifiable probe hybridization (MAPH) as well as the multiplex ligation-dependent probe amplification (MLPA), which both rely on the sequence specific hybridization of probes to a target-DNA. Hybridized probes are amplified and the PCR products obtained are detected semi-quantitatively. ART-MLPA is for example disclosed by Eldering, E. et al. (Nucleic Acids Research 31(23) (2003), 53). Said method is used for the detection of several transcripts from a sample and allows the exact identification of transcription patterns.

An alternative method for the amplification of signals resides in that the signal of the sample itself is amplified by e.g., enzymatic reactions.

So far, none of the methods known in the art result in a satisfactory and reliable sensitivity of the tests, in that also sample-nucleotides, e.g., RNA-molecules, contained in said sample merely in small amounts, may be also quantitatively detected in a reliable manner.

### SUMMARY OF THE INVENTION

An object of the present invention thus resides in the provision of an improved method for the detection of RNA populations, with which the qualitative and quantitative detection of RNA is made possible, which RNA is present in the cell merely with a low copy number.

This object has been achieved by a method for the detection and quantification of RNA, comprising the steps of: (a) providing a RNA-pool, (a) adding of at least a first DNA molecule to the RNA-pool, which first DNA is complementary to a first segment of a RNA of interest, and at least a second DNA-molecule, which is complementary to a second segment of the RNA, which second segment is different from said first segment, under conditions, which allow binding of complementary strands, (c) binding the heteroduplex molecules to a support, (d) releasing of the second DNA-molecule from the heteroduplex molecules, and (e) contacting the second DNA-molecule with an array, which has at known locations thereof molecules, to which molecules the second DNA-molecule may bind.

### BRIEF DESCRIPTION OF THE DRAWINGS

FIG. 1 schematically shows the course of the process up to the extraction of the detector-probes.

FIG. 2 schematically shows the result of a hybridization of the detector-probes with an array.

FIG. 3 schematically shows the course of the process under the use of amplifiable detector-probes.

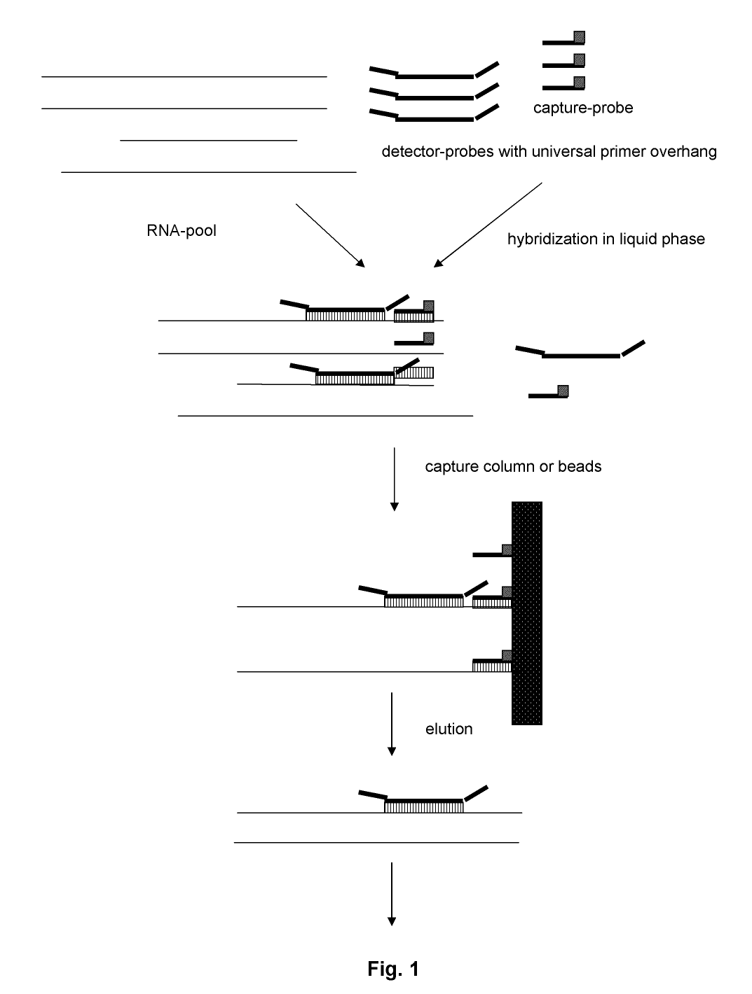

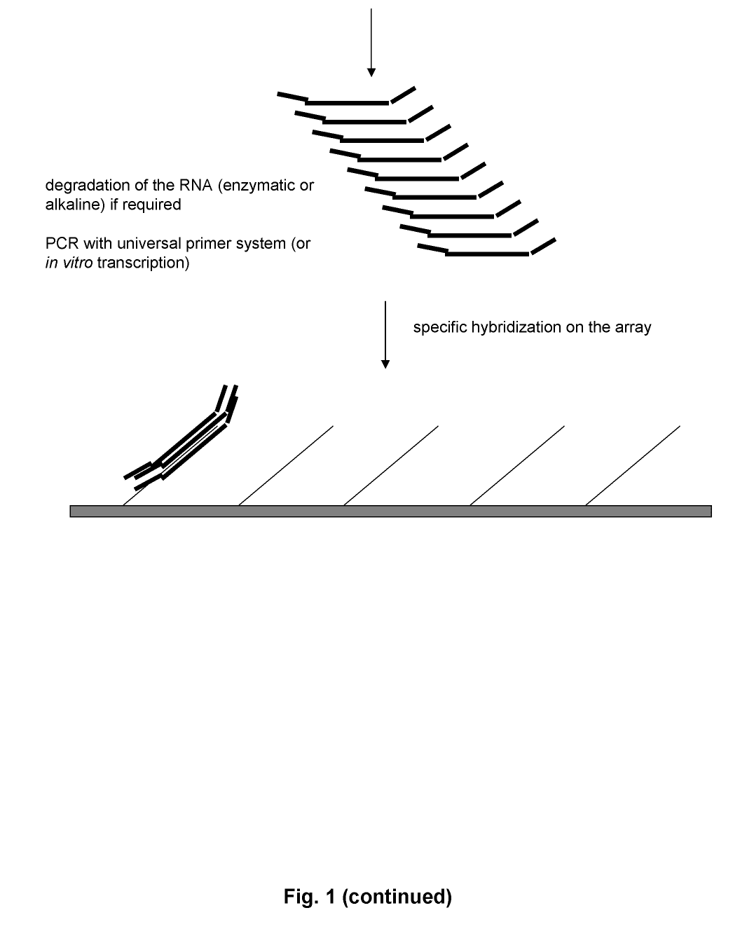

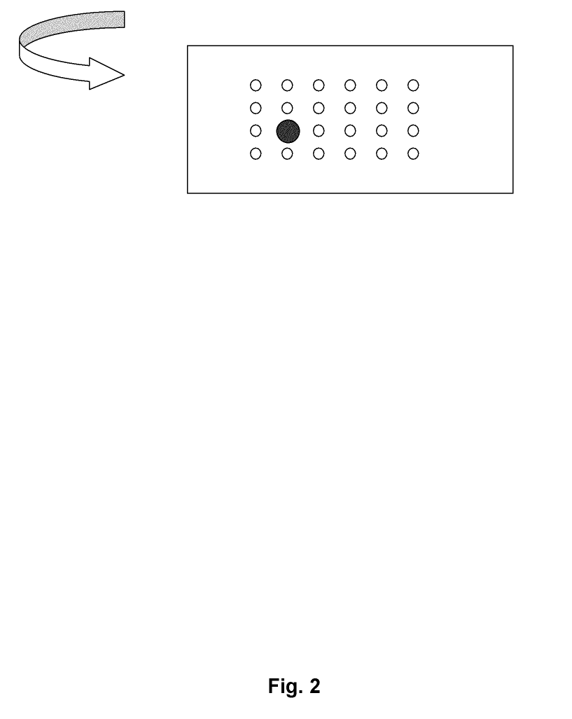

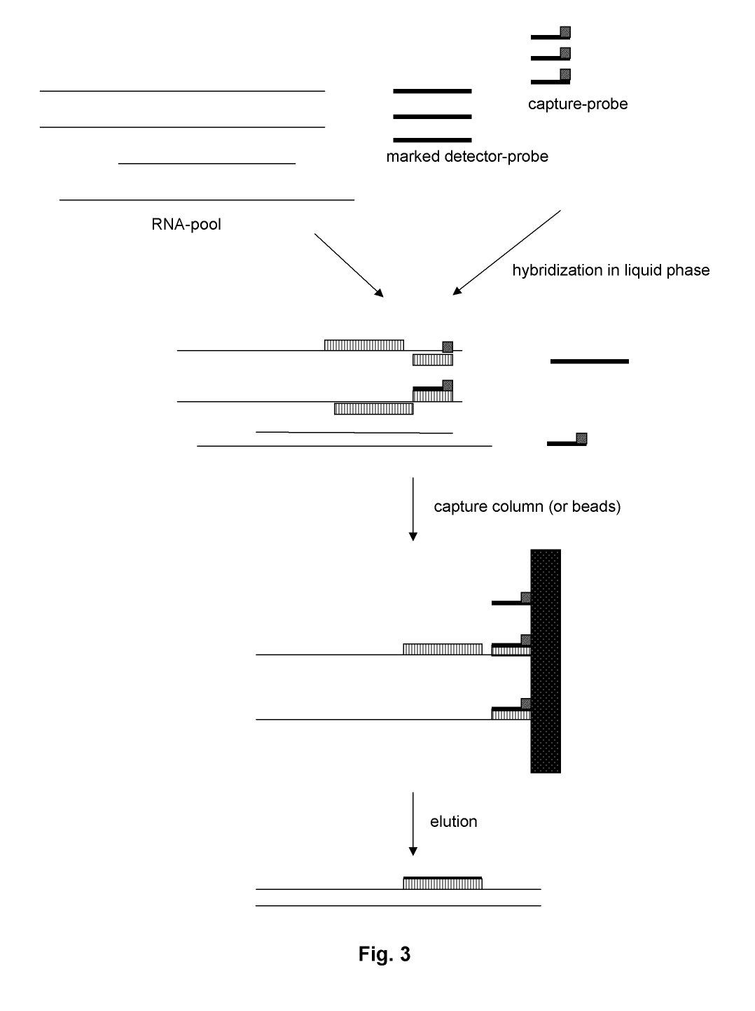

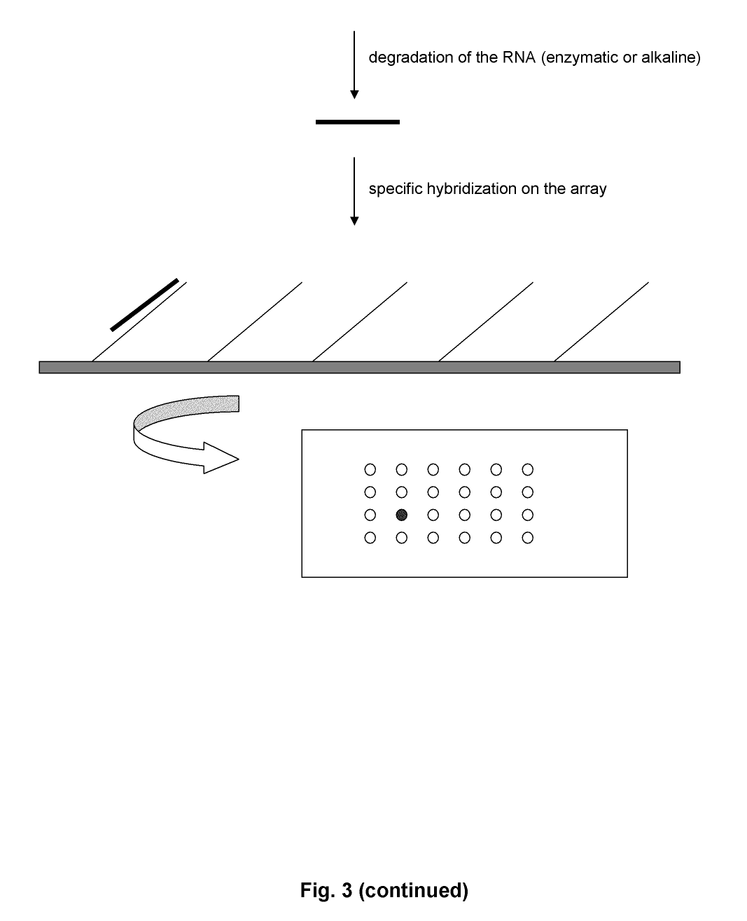

### DETAILED DESCRIPTION OF THE PREFERRED EMBODIMENT

### Definitions

In the present invention, the term “nucleotide” includes DNA and RNA, which contain adenine, cytosine, guanine, thymine and uracil, respectively, as bases and deoxyribose and ribose as the structural elements. Furthermore, a nucleotide may also comprise any modified (artificial) base, which is capable of base pairing using at least one of the above bases (for example inosine). This may be used for example for the design of probes, particularly the capture probes, in case a lower stringency of the hybridization is desired at a particular location(s) of the respective nucleotide sequence.

In the context of the present invention, all kinds of RNA, messenger-, transfer- and ribosomal-RNA (mRNA, tRNA and rRNA, respectively) may be used. mRNA contains as a portion, which is not encoded by a corresponding DNA, the so-called poly(A) tail, which is characteristic for this kind of RNA and hybridizes to the corresponding poly-dT sequence.

The term “transcript” relates to the RNA as such, but also to a copy of the RNA in a corresponding DNA molecule.

The expression “differential transcription” describes the transcription of particular genes, which are activated by a cell in a particular state. The RNA is also presented in a certain copy number in a cell, which gives an indication about the average number of RNA molecules contained per cell. Low copy numbers of a specific RNA are for example in the range from about 1 to 50 molecules per cell.

The “nucleic acid” may be, in the case of the capture and detector molecule, long chained polynucleotides of a length up to 1000 nucleotides. The nucleic acids on the array, representing the nucleotide sequences to which the detector probes may hybridize, are usually shorter polynucleotides and/or oligonucleotides and are immobilized either by a chemical covalent bond or by adhesion to the support of the array. The length of the immobilized nucleic acids encompasses the range of at least from about 10 to about 500 nucleic acids (10-mers to 500 mers), preferably from about 10 to about 100, more preferably from about 20 to about 80 nucleic acids, even more preferably at least from about 20 to about nucleic acids, as well as at least from about 20 to about 40 nucleic acids and most preferably from at least about 20 to about 30 nucleic acids. The nucleic acids may be synthesized in a manner well known to the skilled person.

The term “heteroduplex” as used herein relates to a DNA/RNA hybrid. Said term refers in general to any double stranded hybrid formed by annealing of single strands from different sources. If there is a sequence difference between the strands, the heteroduplex may show single strand loops or bubbles (unpaired regions).

The expression “hybridization” as used in the present invention describes an attachment/binding/duplex formation of a molecule or a portion of a molecule to another molecule or portion of another molecule under stringent conditions and formation of hydrogen bonds. The hybridization event is in the present context the detectable occurrence of hybridization and may be detected via any method well known to the skilled person, such as e.g., chemo-luminescence, confocal laser induced fluorescence, calorimetry, electrochemistry, radioactivity and surface resonance.

Of particular importance with regard to hybridization and the optimal conditions when it occurs is the stringency of the conditions chosen for the hybridization. Stringency refers to temperature, ionic strength conditions, pH, and presence or absence of certain organic solvents and/or detergents during hybridization. The higher the stringency, the higher will be the required level of complementarily achieved between hybridizing nucleotide sequences. The term “stringent conditions” designates conditions under which only nucleic acids having a high frequency of complementary bases will hybridize. Conditions of high stringency may be achieved by selecting a high temperature and a low salt concentration, whereas a low temperature, a high salt concentration and solvents like Dimethylsulfoxide (DMSO) or Dimethylformamide (DMF) favor unspecific hybridization reactions. Conditions of different stringency for nucleic acid hybridizations are exemplified in Sambrook et al., Molecular Cloning, A Laboratory Manual, Cold Spring Harbor, Laboratory Press, 3^{rd} Edition (ISBN 0879695773).

The term “amplification” as used herein refers to an increase of the number of copies of a specific DNA fragment; which is in the present case (amplification of the capture probe) in vitro. The in vitro amplification is performed by PCR (polymerase chain reaction), which represents a well known technique to the skilled person.

“Micro-arrays” comprise a support or carrier, which may be produced by means of any customary material, such as glass, silicone, silicone-dioxide, plastics, e.g., nylon, metal and mixtures thereof, and may further have for example the form of discs, panels, gel layers and/or beads. The support has on its surface several single regions, which bear particular nucleotide sequences, which may bind (via hybridization) to (a) respective nucleotide sequence(s), in the present case the detector probe(s), and yield a specific pattern on the micro-array. If the target-sequence is suitably marked, a signal may be detected, identified and quantified directly at the binding site. The intensity of the signal allows further an estimation of the amount of target-sequence present in the sample. The nucleotide sequence to be identified may be marked prior hybridization.

The “marking” or “labeling” is well known to the skilled person and may be performed for example during an amplification of the target sequence by incorporation of labeled nucleotides or alternatively by attachment of a marker to the hybrids (amplicons). In case of incorporation of labeled nucleotides during the amplification reaction a higher sensitivity of the assay may be obtained, depending on the length of the amplified sequence and the amount of marker in the hybridized target molecule. Marking or labeling is either performed by radiography, fluorescence, calorimetry or mediated by electrical impulses. Suitable markers comprise for example biotin, digoxigenin, dinitrophenol or similar. Both, marking and the detection of the markers represent techniques well known to the skilled artisan.

The most common “method for the detection of fluorescent dyes”, which is preferably used in the present invention, is the confocal laser induced fluorescence, in which the hybridization event is detected by using marker molecules in the form of fluorescent dyes linked to the probe nucleic acid. Such dyes comprise for example cyanine dyes, preferably Cy3 and/or Cy5, renaissance dyes, preferably ROX and/or R110, and fluorescent dyes, preferably FAM and/or FITC.

A “diagnostic kit” ‘comprises the respective means (for example, chemicals, buffers, manual, etc.) to perform the inventive method

The present invention pertains to a fast and highly sensitive method for the qualitative and quantitative detection of RNA by micro-arrays, by connecting sequence specific RNA-purification with micro-array-analysis.

For accomplishing the present method, in a first step a RNA-pool, such as e.g., supplied by a cell, is provided. The RNA contained in a cell may be used directly as such, i.e., the cell lysate may be used directly, without the necessity to specifically purify the total RNA or mRNA contained therein. This has the particular advantage, that by omitting such a purification step no tampering may occur, e.g., with regard to the population of a specific RNA species, particularly with RNA species of a low copy number. Naturally, the RNA may, if desired, be purified and isolated, respectively, by means of conventional methods, as described for example in Sambrook et al., Molecular Cloning, A Laboratory Manual, Cold Spring Harbor, Laboratory Press, 3^{rd} Edition (IS:BN 0879695773).

The RNA will be contacted in a subsequent step with at least a first DNA-molecule, which is designated “capture probe”, and further with a second DNA-molecule, which is designated herein as “detector probe”.

The first nucleotide has a sequence, which is complementary to a first segment of a RNA of interest, which first segment is different from said second segment, to which the detector probe hybridizes. This sequence may be on the one hand poly-dT, in that the capture probe(s) only bind to mRNA in the entire RNA-pool. Alternatively and preferably, this sequence may be complementary to a first segment of a particular RNA of interest (i.e., a RNA to be tested), which is substantially specific for this RNA and related RNA molecules (e.g., transcripts of a gene family), respectively. In this case, the hybridization of the capture probe solely occurs to the respective RNA of interest or the particular transcripts. In general, the capture probe has a length of between 40 and 200 nucleotides, preferably between 40 and 100, more preferably between 40 and 80 nucleotides.

The capture probe has in addition to a first segment, hybridizing to a RNA of interest, a second segment, with which a specific isolation of the capture probe out of the mixture is enabled or facilitated, respectively. This segment may be each group of a binding system, such as a particular nucleotide sequence (to which as binding partner a complementary nucleotide sequence thereto is envisaged), or another molecule, such as biotin, digoxigenin, dinitrophenol or similar.

The second nucleotide has a sequence, which is complementary to a specific second segment of a RNA molecule of interest. This second segment represents in common the segment to be determined, e.g., with respect to a mutation in the nucleotide sequence, or a segment specific for a particular RNA species, in that the presence of the RNA species may be detected. The detector probe has generally a length of between about 20 and 1000 nucleotides, preferably between 20 and 500, more preferably between about 30, 40, or 50, respectively and 200 nucleotides.

The detector probe and capture probe are contacted with the RNA-pool under conditions, which allow the hybridization of complementary strands. Thereby, the detector probe will bind specifically to the RNA of interest, i.e., to the particular complementary segment of RNA, while the capture probe will bind either to all mRNAs (when using a poly-dT sequence) or to a RNA of a particular gene family, which have a substantially identical sequence (by use of a sequence which is uniform for a gene family), or to the specific RNA I of interest (by use of a specific sequence for a particular RNA of interest).

The mixture obtained in this way, comprising free RNA (to which none of the used DNA-molecules has bound), free detector and capture probes, as well as heteroduplexes of RNA+detector probe+capture probe and of RNA+capture probe, is now contacted with a means, which allows the specific extraction, isolation or separation, respectively, of all molecules in which the second segment of the capture probes is present, i.e., the capture probes themselves as well as any RNA molecules hybridized thereto.

If the capture probe has as the second segment a nucleotide sequence, then as the means for extraction a DNA-molecule may be used, which DNA-molecule may be immobilized to or on a carrier and is complementary to said nucleotide sequence (of the second segment of the capture probe). As the carrier each kind of suitable material may be used, to which nucleic acids may be bound, such as microbeads (which are contacted with the mixture), or a column (above which the mixture is passed). Other suitable carriers comprise for example nylon membranes or modified class or plastic surfaces.

Alternatively, the second segment of the capture probe may be a group/molecule, for which a suitable binding partner exists, which may be bound to a carrier as exemplified above. Examples comprise in general antigens, e.g. haptens like dinitrophenol or digoxigenin (with an antibody as binding partner bound to the carrier, or biotin (with streptavidin or avidin as binding partner bound to the carrier).

Unbound material, i.e., all molecules which do not contain a capture probe (RNA to which no capture probe has been bound, free detector probe(s)) are removed, e.g., by washing of the support and removal of material, which did not bind via a binding partner to the support, or by withdrawal of microbeads and a washing step, so that in the mixture obtained only the capture probe and in dependency for the selected sequence of the capture probe hetero-duplexes between capture probe and the RNA (e.g. mRNA as such, or RNA of a gene family), as well as heteroduplexes, which have the capture probe and the detector probe as well as the corresponding RNA of interest. As outlined above, it is of particular advantage, in case a high specificity is desired, if the capture probe is complementary to an segment of the RNA of interest, in that in the extraction/isolation step substantially only RNA is co-isolated, to which also a capture probe has bound.

Afterwards, the detector probe(s) bound to the RNA are released. This may be performed by denaturation of the heteroduplex strands, e.g., via chemical treatment, for example with a weak alkaline solution, or enzymatic treatment, for example by degradation with RNA degrading enzymes, such as RNAse. Thereby, free and unbound detector probe(s) is/are obtained for further analysis.

In a preferred embodiment, the detector probes have at their respective 5′- and 3′-ends two additional segments, which allow amplification of the detector probe. The respective 5′ and 3′ ends are further flanking said segment, which is complementary to a particular RNA sequence of the RNA of interest. Such segments may be nucleotide sequences, which may serve as binding locations for primers in a subsequent amplification step by PCR. Such nucleotide sequences have in general a sequence and a length, which do not interfere disadvantageously at a hybridization with the sequence specific for the RNA of interest, the length comprises normally about 10 to 25 nucleotides, preferably about 12 to about 18 nucleotides. Alternatively, these two segments may have the nucleotide sequence of the T3 and T7 promoter, which allows the linear amplification by in vitro transcription.

The detector probe(s), which represent(s) an exact image of the RNA of interest, is/are either contacted directly with an array or is/are amplified by the respective means prior to the contacting step, see e.g., Sambrook et al., Molecular Cloning, A Laboratory Manual, Cold Spring Harbor, Laboratory Press, 3^{rd} Edition (ISBN 0879695773).

For the detection of a binding of the detector probe to a particular location on the array, a label attached to the detector probe is utilized. Such label may be attached to the detector probe prior to contacting it together with the capture probe with the RNA-pool (in step (a)), or may be incorporated after releasing the detector probe from the heteroduplex, i.e., after step (d).

According to a preferred embodiment, specifically, in case a low transcript number RNA is to be detected, the detector probe is amplified after step (d). During the amplification process a label may be incorporated into the new molecules produced, such as e.g., a radioactive nucleotide, or attached thereto, e.g., labeled indirectly by means of markers like biotin, digoxigenin or dinitrophenol and afterwards visualized by fluorescent dyes attached to streptavidin or specific antibodies, respectively.

The array to which the detector probes will be hybridized after an optional amplification step, has at known locations particular molecules, to which the detector probe(s) may bind. The array is usually attached to a support, such as glass, silicon-support, silicon dioxide, metal, polymeric substances/plastics or mixtures thereof and may have the form of discs, panels, gel layers and/or beads.

The molecules on the array are usually nucleotides with different sequence, may also be a binding partner in a system, e.g., antigen-antibody, wherein a binding partner is located at the detector probe and the other on the array. In a preferred embodiment, oligo- and polynucleotides respectively with different sequences are on the support in a known layout, namely the array. The detector probe will bind now to the location on the array, at which location a complementary nucleotide sequence is attached to the support.

The pattern on the array obtained by the hybridization reaction, as well as the strength of the signal are indicative for the qualitative and quantitative presence of a transcript in a cellular system.

The method is particularly suitable for the detection of a differential transcription of a gene of interest, e.g. as an answer to external, changed environmental conditions, e.g., by contacting the cell with a chemical agent, or developmental stages in a cell. Alternatively, the method may be used for the quantitative detection of alternatively spliced RNA products or simply for the analysis of mutations in particular transcripts.

An advantage of the herein disclosed method resides particularly, in that it is independent from the presence of a substantially complete or full-length RNA molecules. The method may be also used successfully in the presence of partially degraded RNA, with the proviso that the segments on the RNA to which the detector probe and the capture probe will bind is substantially intact.

In an alternative embodiment, in the first step (a) several detector probes may be used, all of which being specific for one RNA-molecule of interest and for one specific sequence, based e.g., on mutations in the gene of interest. E.g., in case a point mutation is known to occur in one gene, two detector probes may be used that harbor a different label each, so that binding of either of the two detector probes to the given segment on the RNA, depending on the sequence, i.e., the mutation, will be indicative whether in the sample investigated the mutation is present or the native sequence.

In an alternative embodiment the more than one detector probe for one given RNA molecule may be used for detecting the presence of more than one mutation at the same time.

Also, in case more than one detector probe is used for a given RNA molecule, one detector probe is selected such to be specific for a segment of the RNA of interest, such as a segment containing a mutation or not, whereas the second detector probe will bind to another segment of the RNA of interest. In the hybridization step on the array, for both positions on the array the same signal strength has to be obtained, in that the second detector probe may serve as positive control and as internal marker, if the first detector probe binds to the segment comprising the putative mutation.

Alternatively, more than one detector probe may be added to the RNA-pool, to perform simultaneously several detection steps with regard to different RNA species, such as a detector probe specific for a mutation in a transcript and a detector probe for the non-mutated transcript. In order to obtain improved possibilities for distinction in the case more than one detector probe is used, the detector probes may be marked variably by e.g. different fluorescent dyes.

The present method is highly specific, since on the one hand the at least one detector probe as well as optionally the capture probe are specific for the particular RNA of interest. In the case that the detector probe is specific for the RNA of interest, in an optional subsequent amplification step only than a higher amount of DNA is obtained, if the detector probe bound to the RNA of interest and took along the other method steps as well by means of the binding to the capture probe. If further the capture probe is selected in such a way, that it is also specific for the RNA of interest, the first step already comprises a selection towards the RNA of interest.

Another advantage of the present method resides also in a highly improved hybridization kinetic on the array, due to the already known length of the samples, particularly the detector probe(s). Since respective transcripts are absent, only a specific hybridization of longer transcripts/samples to the probes bound to a support in an array may occur. This renders a tampering of the results impossible.

The example is intended to illustrate the present invention, without limiting it.

### Example

a) Examination of the changes of the differential gene expression of Hela cells by the culture medium.

Hela cells were cultivated for a period of two weeks either in medium 1 (Dulbecco's modified eagle's media, 5% FCS) or medium 2 (Dulbecco's modified eagle's media, 20% FCS).

10⁵ cells were used for the isolation of RNA. The RNA was isolated according to standard methods (Sambrook et al., Molecular Cloning, A Laboratory Manual, Cold Spring Harbor, Laboratory Press, 3^{rd} Edition (ISBN 0879695773).

Tested genes: GAPDH, MMP-19, ribosomal protein S27a

MMP-19 capture probe:
3′-ttcggactga agagtcgm ggaggggggt cggggttcgg
ggaatcccac
MMP-19 detector probe:
3′-agggaccgga atggggtagt taagaatcga ccggaagm
cgggtagagt
GAPDH capture probe:
3′-gtcttctgac acctaccggg gaggcccm gacaccgcac
taccggcgcc
GAPDH detector probe:
3′-accatagca ccttcctgag tactggtgtc aggtacggta
gtgacggtgg
S27a capture probe:
3′-aaacgaccgt tcgtcgacct tctacctgca tgaaacagac
tgatgttata
S27a detector probe:
3′-ggttctaggt cctattcctt ccttaaggag gactagtcgt
ctctgactag

Detector probes were marked by the 5′ end with Cy3.
Capture probes were marked by their 5′ end with biotin.

b) Test conditions For the analysis 2 μg total RNA were used, respectively.

Total hybridization volume: 50 μl; hybridization buffer: 2×SSC, 2% SDS; hybridization time: 3 hours; temperature: 68° C.; concentration of the detector probes and capture probes: each 500 nM

Purification of the capture probes with bound RNA inclusively bound detector probes by streptavidin coated magnetic beads according to the manufacture instructions (Dynal). 3 times washed in hybridization buffer.

RNAse digestion with a mixture of RNAse A and RNAse H at the beads. Such isolated capture probes were removed from the supernatant and hybridizes directly in hybridization buffer to a DNA micro-array.

Used DNA micro-array: DualChip™ human general (Eppendorf AG) Hybridization was performed according to the manufacture instructions (standard conditions). The micro-array was read with a Genpix 4000A and analysed.)

c) Results Signals for all three probes were detected.

GAPDH and S27a exhibited the same expression level in both preparations, MMP-19 was in medium 2 in comparison to medium 1 about a factor of 5 up-regulated.

What is claimed is:

1. A method for the detection and quantification of RNA, comprising the steps of:
(a) providing a RNA-pool,
(b) adding at least a first DNA-molecule to the RNA-pool, which first DNA molecule is complementary to a first segment of a RNA of interest, and at least a second DNA-molecule, which is complementary to a second segment of the RNA, which second segment is different from said first segment, under conditions, which allow binding of complementary strands, thereby obtaining heteroduplex molecules,
(c) binding the heteroduplex molecules to a support,
(d) releasing the second DNA-molecule from the heteroduplex molecules, and
(e) contacting the at least one second DNA-molecule with an array, which has attached thereto at known locations thereof molecules, to which the at least one second DNA-molecule may bind.

2. The method of claim 1, wherein said first DNA molecule has at the 3′ and 5′ ends further nucleotide sequences, which may be used for the amplification of said first DNA-molecule and wherein the method further comprises the step of amplification of the second DNA-molecule released in step (d) prior step (e).

3. The method according to claim 2, wherein said amplification step is performed by means of in-vitro amplification under use of T3-polymerase or T7-polymerase.

4. The method of claim 1, wherein a cell lysate is used as RNA-pool.

5. The method of claim 1, wherein the length of said first DNA-molecule is in the range of 50 to 200 nucleotides and the length of said second DNA-molecule is in the range of 40 to 80 nucleotides.

6. The method of claim 1, wherein the sequence of said second DNA-molecule is specific for a RNA of interest.

7. The method of claim 1, wherein two detector probes are used for the same RNA species.

8. The method of claim 7, wherein the visualization of the binding of the detector probe to a particular segment on the array is performed by radiography, fluorescence, calorimetry or mediated by electrical impulses.

9. A method for the detection of diseases, comprising conducting the method of claim 1 thereby detecting the transcription or the change of the structure (mutation) of a particular gene.


SEQUENCE LISTING (6 sequences)

SEQ ID NO: 1 - DNA, 50 bp, Artificial Sequence
  artificially generated probe
ttcggactgaagagtcgtttggaggggggtcggggttcggggaatcccac

SEQ ID NO: 2 - DNA, 50 bp, Artificial Sequence
  artificially generated probe
agggaccggaatggggtagttaagaatcgaccggaagtttcgggtagagt

SEQ ID NO: 3 - DNA, 50 bp, Artificial Sequence
  artificially generated probe
gtcttctgacacctaccggggaggccctttgacaccgcactaccggcgcc

SEQ ID NO: 4 - DNA, 49 bp, Artificial Sequence
  artificially generated probe
accatagcaccttcctgagtactggtgtcaggtacggtagtgacggtgg

SEQ ID NO: 5 - DNA, 50 bp, Artificial Sequence
  artificially generated probe
aaacgaccgttcgtcgaccttctacctgcatgaaacagactgatgttata

SEQ ID NO: 6 - DNA, 50 bp, Artificial Sequence
  artificially generated probe
ggttctaggtcctattccttccttaaggaggactagtcgtctctgactag